(19) United States
(12) Patent Application Publication
(10) Pub. No.: US 2005/0017713 A1
(43) Pub. Date: Jan. 27, 2005

(54) Weld characterization using eddy current sensors and arrays

(75) Inventors: Neil J. Goldfine, Newton, MA (US); David C. Grundy, Reading, MA (US); Vladimir A. Zilberstein, Chestnut Hill, MA (US); Mark D. Windoloski, Burlington, MA (US); Darrell E. Schlicker, Watertown, MA (US); Andrew P. Washabaugh, Chula Vista, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: JENTEK Sensors, Inc., Waltham, MA (US)

(21) Appl. No.: 10/864,297

(22) Filed: Jun. 9, 2004

Related U.S. Application Data
(60) Provisional application No. 60/476,987, filed on Jun. 9, 2003.

(51) Int. Cl. G01N 27/82

(52) U.S. Cl. 324/240

(57) ABSTRACT

Eddy current sensors and sensor arrays are used to characterize welds and the welding process schedule or parameters. A sensor or sensor array is placed in proximity to the test material, such as a lap joint or a butt weld, and translated over the weld region. Effective properties associated with the test material and sensor, such as an electrical conductivity or lift-off, are obtained for the weld region and the base material at a distant location from the weld region. The effective properties or features obtained from the effective property variation with position across the weld are used to assess the welding process parameters.

### RELATED APPLICATION(S)

This application claims the benefit of U.S. Provisional Application No. 60/476,987, filed on Jun. 9, 2003. The entire teachings of the above application are incorporated herein by reference.

### BACKGROUND OF THE INVENTION

This application relates to nondestructive materials characterization, particularly as it applies to post and in-process weld scanning for quality control, in-process monitoring and seam tracking using eddy current sensors.

There is an increasing need for a nondestructive method for assessing the quality of welds between materials, including the detection and characterization of defects. In particular, friction stir welding is becoming more commonly used as a joining technique for a variety of metals, including aluminum, titanium and nickel base alloys as well as steels. The quality of the weld depends upon a variety of factors, including the materials, the rotation rate, feed, positioning, applied pressure from the pin tool and the penetration ligament. Defects such as cracks, lack of penetration (LOP), and lack of fusion can compromise the integrity of the joint and can lead to component failure.

Weld examinations are currently performed to characterize the quality of the welds, qualify a welding procedure or qualify welders. These examinations are performed to detect cracks, lack of fusion, lack of penetration, areas of excessive porosity or unacceptably large inclusions. Liquid penetrant inspection (LPI) is widely used for detection of surface-connected defects in welded components fabricated from nonmagnetizable materials. In some cases, LPI fails to detect these surface-connected defects, such as in the case of tight cracks, cracks densely filled with foreign matter or weakly-bonded LOP defects in friction stir welds (FSWs).

For components fabricated from magnetizable materials, such as carbon and low-alloy steels, magnetic particle inspection (MPI) is typically used for detection of surface-connected cracks. Some MPI techniques are claimed to detect cracks that are masked by smeared metal so that the cracks are not directly exposed to the surface. Furthermore, MPI is permitted for inspection through thin coatings typically less than 0.003 in. (0.075 mm) thick. However, MPI is limited in crack detection capability and, for coated surfaces, may require coating removal. Methods are needed to inspect carbon and low-alloy steel components for cracks that are below the MPI detection threshold and for inspections that do not require coating removal. There is also a need to characterize residual stresses in these welds. Other conventional nondestructive testing methods such as conventional eddy current sensing are limited in their sensitivity to small flaws in welds and in their capability to extract spatial information about changes in the weld microstructure and flaw characteristics. The use of conventional eddy current sensing often involves extensive scanning along and across the weld.

Etching with a variety of metallographic etchants is also used to reveal macrostructural or microstructural characteristics of welded joints, including weld metal, heat-affected zone and base metal. In the case of FSW, which is a solid state joining process by plastic deformation and stirring below the solidus temperature, etching can reveal the dynamically recrystallized zone (DXZ), thermomechanically affected zone (TMZ), heat-affected zone (HAZ) and base metal. Etching of FSWs can also be used as a method for characterizing LOP defects, by revealing the relevant width of the DXZ. For example, as shown in FIG. 1, the DXZ, TMZ and HAZ are revealed after etching as distinctly different zones permitting direct measurement of the width of the DXZ that has penetrated to the backside of the welded panels. Etching of panels joined by FSW would, in the case of butt welds, reveal these zones on both the front and back sides. Unfortunately, the etching process is time consuming, not practical for inspection of long welds required for large structures, such as spacecraft and aircraft, not environmentally friendly and often not permitted in production. Methods are needed to inspect these surfaces rapidly and nondestructively.

It is often critical to characterize microstructural variations of metal products such as ingots, castings, forgings, rolled products, drawn products, extruded products, etc. Etching of selected samples is used for this purpose but is not practical or permissible for large surfaces or statistically significant quantities, areas or lengths. It is definitely not acceptable for 100 percent inspection of these products when information on microstructural variations, including imaging of these variations and their quantitative characterization, is required over the entire surface of a product. Furthermore, etching of large surfaces in components that are suspected to contain local zones that are microstructurally different due to fabrication problems, service-induced or accident-induced effects is not practical, unless the locations of such zones are known a priori.

### SUMMARY OF THE INVENTION

The use of eddy current sensors and high resolution conformable eddy current sensor arrays permits the assessment of joint quality and joining process parameters for butt and lap joint friction stir welds. In one embodiment of the invention, a welding process parameter is assessed from features of eddy current measurements of effective material properties associated with the test material and sensor at plural locations across the weld, including positions at the center of the weld and distant from the weld region. The effective properties, such as the magnetic permeability and electrical conductivity, can be absolute properties if models for relating the sensor response to the material properties accurately represent the geometry of the material. In an embodiment, these models are used to create databases of sensor responses, prior to data acquisition on the test material, which permit the inversion of sensor response values into the effective properties. In another embodiment of the invention, the effective property is the lift-off or proximity of the sensor to the test material. In some embodiments of the invention, the welding process parameter is the pin tool rotation direction, rotation rate, plunge force, or travel speed.

The features for assessing the welding process parameters are typically obtained from scans over a weld to yield effective property measurements. In one embodiment, the feature is the width of the weld region. In another embodiment, the feature is the uniformity of the effective property along the weld. In yet another embodiment, the feature is the change in an effective property near the center of the weld region compared to the effective property obtained away from the weld. Depending upon the electrical and geometric properties of the joined materials, including the electrical conductivity, magnetic permeability, and thicknesses, the effective properties near the center of the weld may be larger or smaller than the corresponding effective property away from the weld. In another embodiment of the invention, two or more features are used to assess the welding process parameters. In one embodiment, the welding process parameter is then inferred from a comparison to similar measurements performed on a reference material.

In another embodiment of the invention, friction stir welds are characterized by eddy current sensors and sensor arrays having a drive winding that has at least one linear extended portion for imposing a magnetic field. The windings can be fabricated onto rigid or conformable substrates. Sensing elements placed near an extended portion of the drive winding respond to the properties of the test material. A single sensing element can be placed between a pair of extended portions or numerous sensing elements can be placed in one or more rows parallel to the extended portion. This facilitates imaging of the material properties, particularly when the sensor array is scanned in a direction perpendicular to the row of sensing elements. High spatial resolution images can be obtained by orienting the row of sense elements parallel to the weld axis and scanning transversely across the weld, with one or more scans then required to completely image the weld. The weld can be imaged with a single scan if the row of sense elements is oriented perpendicular to the weld axis and then scanned longitudinally along the weld, at the expense of a lower spatial resolution image across the weld. Alternatively, the row of sense elements can be oriented at an angle to the weld axis, typically less than or equal to 45 degrees, and scanned longitudinally along the weld. This permits the weld to be imaged in a single scan and still allows a relatively high spatial resolution image to be obtained across the weld. This is particularly suitable to the imaging of weld lap joints of thin material layers where the weld zone itself is relatively thin. In an embodiment, the second row is at the same distance to an extended portion of the drive winding as the first row to create complementary images of the material properties. In another embodiment, the second row of sense elements is at a different distance to the extended portion of the drive winding in order to sample different components of the magnetic field distribution.

The measurements with an eddy current sensor or sensor array are performed with time varying magnetic fields. In one embodiment of the invention, the electric current for creating the magnetic field varies sinusoidally in time at a prescribed excitation frequency. The excitation frequency influences the measurement response. In one embodiment, a single high frequency measurement is made of conductivity and proximity at each sensing element to measure only the near surface properties of the material. In another embodiment, multiple frequencies are used to determine, for example, the variation of material properties with depth from the surface. In a lap joint, for example, a high frequency can be used to probe the near surface properties while a low frequency can be used to penetrate into materials on the opposite side of the layer nearest the sensor. Preferably, the excitation frequency is in the range of 100 Hz to 100 MHz, with the actual frequency selection dependent upon the desired sensitivity and the properties (electrical and geometric) of the test material.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a cross-section of a friction stir weld with lack-of-penetration defect in Al—Li alloy plate;

FIG. 2 illustrates a cross-section of a friction stir weld for a lap joint;

FIG. 3 illustrates a plan view for an MWM sensor;

FIG. 4 illustrates a plan view of an MWM-Array;

FIG. 5 illustrates a plan view of an MWM-Array having multiple elements between the extended portions of the primary winding;

FIG. 6 illustrates a plan view of an MWM-Array having multiple elements within each meander;

FIG. 7 illustrates an expanded view of the drive winding for the MWM-Array of FIG. 6;

FIG. 8 illustrates a representative measurement grid relating the magnitude and phase of the sensor terminal impedance to the lift-off and electrical conductivity;

FIG. 9 illustrates scan orientations of the sensor for LOP and crack detection;

FIG. 10 is a schematic of a two-dimensional image of the backside effective electrical conductivity of a similar metal FSW specimen obtained with a longitudinal scan of a high-resolution MWM-Array with longer segments of the primary winding oriented perpendicular to the weld axis. This specimen has an LOP defect on the left side but has no LOP defect on the right;

FIG. 11 is a schematic of a two-dimensional image of the backside effective electrical conductivity of a similar metal FSW specimen obtained with a longitudinal scan of a MWM-Array with longer segments of the primary winding oriented perpendicular to the weld axis. This specimen has the weld alignment varied with respect to the butt joint between the plates;

FIG. 12 is a schematic of a two-dimensional image of the backside effective electrical conductivity of a zero LOP defect specimen obtained with a longitudinal scan of a MWM-Array with longer segments of the primary winding oriented perpendicular to the weld axis;

FIG. 13 is a schematic of a two-dimensional image of the backside effective electrical conductivity for an LOP defect specimen obtained with a longitudinal scan of a MWM-Array with longer segments of the primary winding oriented perpendicular to the weld axis. This specimen also has intermittent planar flaws;

FIG. 14 is a schematic of the normalized conductivity for a measurement channel of a MWM-Array with longer segments of the primary winding oriented parallel to the weld axis for a similar metal zero LOP defect specimen;

FIG. 15 is a schematic of the normalized conductivity for a measurement channel of a MWM-Array with longer segments of the primary winding oriented parallel to the weld axis for a similar metal 0.05-in. LOP defect specimen;

FIG. 16 is a schematic of the normalized conductivity for a measurement channel of a MWM-Array with longer segments of the primary winding oriented parallel to the weld axis for a similar metal 0.04-in. LOP defect specimen which also has intermittent planar flaws;

FIG. 17 is a schematic of the effective electrical conductivity profile for dissimilar metal FSWs for zero and 0.05-in. LOP defect specimens obtained with transverse scans of high-resolution MWM-Arrays with longer segments of the primary winding oriented parallel to the weld axis;

FIG. 18 is a schematic of the average conductivity profile across several dissimilar metal FSWs obtained with a high-resolution MWM-Array;

FIG. 19 is a schematic of a low frequency normalized conductivity image for a MWM-Array with longer segments of the primary winding oriented parallel to the weld axis for a lap joint specimen with nominal weld conditions;

FIG. 20 is a schematic of a high frequency normalized conductivity image for a MWM-Array with longer segments of the primary winding oriented parallel to the weld axis for a lap joint specimen with nominal weld conditions;

FIG. 21 is a schematic of a low frequency normalized lift-off image for a MWM-Array with longer segments of the primary winding oriented parallel to the weld axis for a lap joint specimen with nominal weld conditions;

FIG. 22 is a schematic of a high frequency normalized lift-off image for a MWM-Array with longer segments of the primary winding oriented parallel to the weld axis for a lap joint specimen with nominal weld conditions;

FIG. 23 is a schematic of a high frequency normalized lift-off image for a MWM-Array with longer segments of the primary winding oriented parallel to the weld axis for a lap joint specimen with tool tip rotation opposite that of the nominal weld conditions;

FIG. 24 is a plot of the DXZ width times stir zone slope feature versus the LOP defect thickness for similar metal FSW;

FIG. 25 is a schematic of the DXZ width feature versus the LOP defect thickness for similar metal FSW;

FIG. 26 is a schematic plot of an effective property for a scan across a lap joint friction stir weld with the effective property in the weld higher than the effective property distance from the weld;

FIG. 27 is another schematic plot of an effective property for a scan across a lap joint friction stir weld with the effective property in the weld lower than the effective property distance from the weld;

FIG. 28 is a schematic plot of an effective property for a scan across a lap joint friction stir weld with a setting change in the weld control parameters;

FIG. 29 is another schematic plot of an effective property for a scan across a lap joint friction stir weld with a setting change in the weld control parameters;

FIG. 30 is a plot of the acceptable region for when two scan features are plotted against one another;

FIG. 31 is an expanded view of an eddy current array with a dual rectangular loop drive winding and two rows of sense elements at different distances to the drive winding;

FIG. 32 illustrates a representative coating thickness/lift-off grid lattice for turbine blade materials;

FIG. 33 is a plot of the multiple frequency conductivity measurements for MCrAlY coatings on IN738 substrates obtained with a single element MWM;

FIG. 34 illustrates a comparison between the coating thickness determined from the coating characterization algorithm, using the data of FIG. 33, and metallography.

### DETAILED DESCRIPTION OF PREFERRED EMBODIMENTS OF THE INVENTION

A description of preferred embodiments of the invention follows. This invention involves an assessment of welding schedules or parameters, weld quality or quality of other linear or curved (i.e., curvilinear) joint or feature in a metal or otherwise conducting or magnetic component, using magnetic field sensors such as MWM-Array eddy current sensors. These methods are also applicable to welds in dielectric materials (i.e., relatively insulating materials) using dielectric or capacitive sensor arrays or sensors. A sensor or an array of sensing elements provide information about effective properties associated with the material and may be used to constructs property images.

A model or empirical calibration method is used to correct for variations in sensor proximity or other variables of interest to produce images of “effective” properties that can be used to assess the process parameter or defects of interest. For example, U.S. Pat. No. 6,727,691 describes the use of property maps to detect and characterize defects given that a proper nominal welding schedule was followed. The defect types include LOP, weak metallurgical (kissing) bonds, planar defects, cracks, worm holes, hook defects, and remnant oxide lines. The present application deals, however, with qualifying the welding process schedule and parameters themselves. Such parameters may include pin tool speed (rotation rate and linear travel), plunge force or pressure applied to pin tool, tool position (both depth relative to the surface and laterally with respect to the butt or stringer), the tool itself (wrong pin length, wrong rotation direction, tool wear, tool damage such as chipped or broken), or changes in the parameters along the weld (such as the machine loosing pressure or a pin tool chipping partway through a weld).

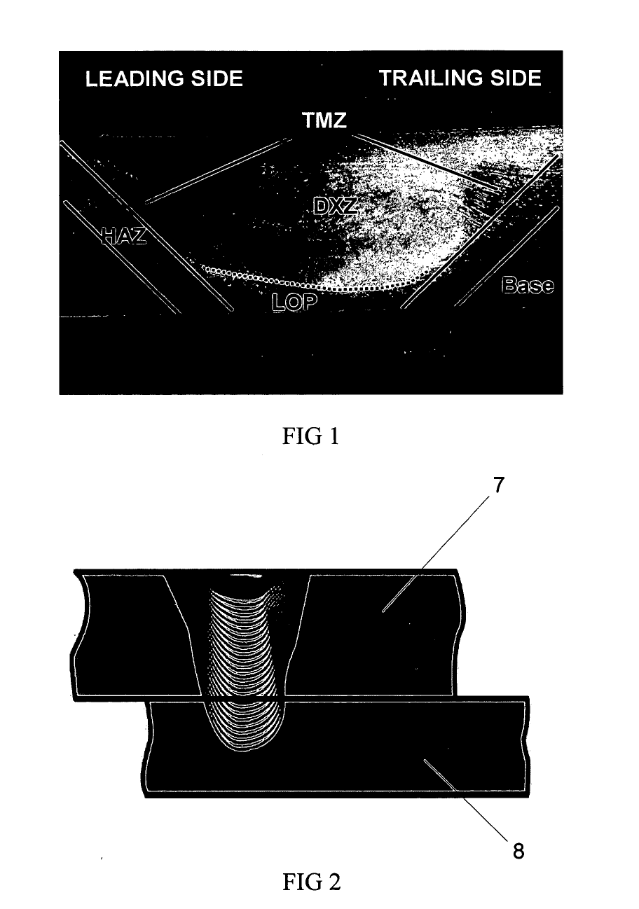

Use of single element sensors and high resolution conformable eddy current sensor arrays can provide quality assessment and manufacturing control of fusion welds, FSWs, metal products such as ingots, castings, forgings, rolled products, drawn products, extruded products, etc. and components with locally different microstructures. A representative photomicrograph of a weld joint, in this case an FSW, is shown in FIG. 1. Friction stir welding is a solid-state joining process. The formation of an FSW is characterized by complex metal flow patterns and microstructural changes. For aluminum alloys, three distinctly different major zones can be typically identified as: (1) a dynamically recrystallized zone (DXZ), or weld nugget, (2) a thermomechanical or heat- and deformation-affected zone (TMZ or TMAZ), adjacent to the weld nugget on both leading and trailing sides of the joint, and (3) a heat-affected zone (HAZ). The HAZ includes material that has been exposed to a thermal cycle which modifies the microstructure and/or mechanical properties but does not involve plastic deformation. The TMZ and DXZ includes material that has been plastically deformed by the FSW tool, but the DXZ has a different microstructure than the nonrecrystallized TMZ. For materials other than aluminum alloys, the entire TMZ region may appear to be recrystallized so that a distinct DXZ region separate from the TMZ is absent. Consequently, methods for characterizing the weld quality based, for example, on the width of the DXZ in aluminum alloys can be extended to be based on the width of the TMZ for other materials. FIG. 2 shows an illustration of an FSW for a lap joint between material layers (7 and 8).

Compared to conventional fusion welds, friction stir welds are known to contain very few types of defects. The two types of defects that have been noted in friction stir welds are: (1) tunnel defects within the nugget and (2) lack of penetration (LOP). LOP exists when the DXZ does not reach the backside of the weld due to inadequate penetration of the pin tool. The LOP zone may also contain a well-defined crack-like flaw such as a cold lap, which is formed by distorted but not bonded original faying, i.e., butt, surfaces. This occurs as a result of insufficient heat, pressure and deformation. However, the LOP can be free of well-defined crack-like flaws, yet not be transformed by the dynamic recrystallization mechanism since temperatures and deformation in the LOP may not be high enough. Although it may contain a tight “kissing bond,” this second type of LOP defect is the most difficult to detect with alternative methods such as phased-array ultrasonic or liquid penetrant inspection. The MWM-Array methods described here offer the potential to reliably detect and quantitatively characterize both types of LOP defects.

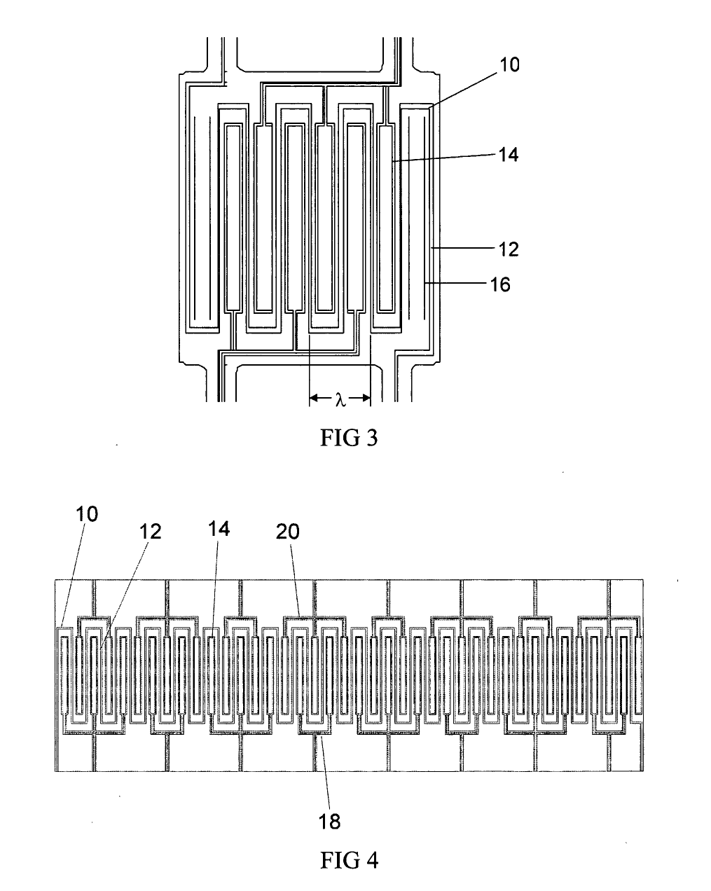

In one embodiment of the invention, eddy current sensors include at least one meandering drive winding and multiple sensing elements are used to inspect the region connecting joined materials. An example sensor is shown in FIG. 3, which shows the basic geometry for a Meandering Winding Magnetometer (MWM™) sensor. The sensor has a meandering primary winding 10 having extended portions 12 for creating the magnetic field and secondary windings 14 within the primary winding for sensing the response of the material under test (MUT). The primary winding is fabricated in a square wave pattern with the dimension of the spatial periodicity termed the spatial wavelength, λ. A time varying current, such as a sinusoidal excitation at a single frequency or a pulse, is applied to the primary winding and a voltage is measured at the terminals of the secondary windings. The magnetic vector potential produced by the current in the primary can be accurately modeled as a Fourier series summation of spatial sinusoids, with the dominant mode having the spatial wavelength λ. The sensing elements can be connected in series to form a single “sense” output signal or individual connections can be made to each element to form an array of “sense” output signals. Passive, dummy, conductors 16 help to maintain the periodicity of the conductor pattern and the magnetic field.

This MWM sensor and MWM-Array sensors have a demonstrated capability to independently measure proximity and material properties as described in U.S. Pat. Nos. 5,015,951, 5,453,689, 5,793,206, and 6,727,691, the entire teachings of which are incorporated herein by reference. The MWM is a “planar” eddy current sensor that was designed to support quantitative and autonomous data interpretation methods. These methods, called grid measurement methods, permit crack detection on curved surfaces without the use of crack standards, provide quantitative images of absolute electrical properties (conductivity and permeability) and permit determination of coating thickness, as well as characterization of process-affected layers, without requiring field reference standards (i.e., calibration is performed in air away from conducting surfaces). The sensors are microfabricated onto a substrate that is typically flexible to provide conformability with curved surfaces; for some applications, the substrate can be rigid or semirigid. The meandering primary windings may be formed by a single conducting element or by a series of adjacent loops, as described in U.S. patent application Ser. No. 09/666,524, filed on Sep. 20, 2000, the entire teachings of which are incorporated herein by reference.

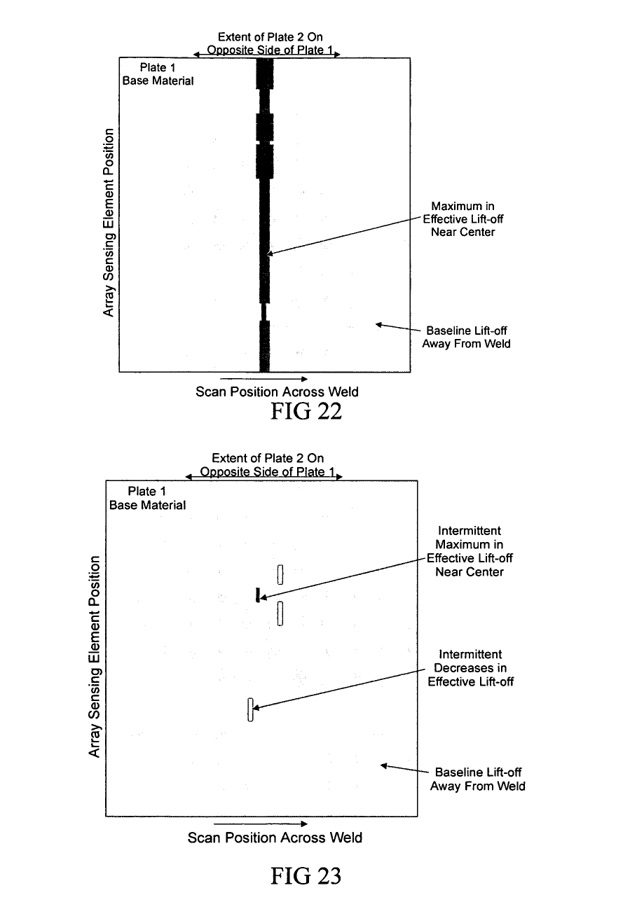

FIG. 4 and FIG. 5 show schematics for two MWM-Arrays. Each array has a primary winding 10 containing extended portions 12 and multiple secondary or sensing elements (14 in FIGS. 4 and 22 in FIG. 5) to permit property images when scanned over a surface. The responses from individual or combinations of the secondary windings can be used to provide a plurality of sense signals for a single primary winding construct as described in U.S. Pat. No. 5,793,206, the entire teachings of which are incorporated herein by reference. In FIG. 4, the sensing elements of the array comprise the combinations of two secondary elements 18 or three secondary elements 20. These sensing elements can also be combined together on an electronic circuit board, away from the surface of the sensor, so that each sensing element pixel contains a group of five secondary elements.

The winding geometry for the MWM makes the response dependent upon the orientation of the sensor with respect to the defect being detected. For example, the eddy currents induced in the material under test (MUT) flow in a plane parallel to the plane of the MWM windings and a direction parallel to the extended portions 12 of the primary winding meanders. Cracks that are perpendicular to the extended portions of the primary winding meanders then interrupt the current path, leading to a decrease in the effective MUT conductivity. In contrast, cracks that are parallel to the extended portions of the primary winding meanders and do not extend beyond the primary winding do not interrupt the induced eddy currents appreciably and the MWM response to cracks in this orientation is diminished. Possible crack-like flaws associated with FSWs include unbonded original butt surfaces either within large LOP or, in the case of a large off-center tool position, outside the lower portion of the joint.

In both FIG. 4 and FIG. 5, the sensing elements provide absolute measurements of the material response. In an alternative embodiment, differential sense elements could also be used, as described for example in U.S. Pat. No. 6,727,691. In each array, current flow through the primary winding creates a spatially periodic magnetic field that can be accurately modeled. The voltage induced in the secondary elements by the magnetic field is related to the physical properties and proximity to the MUT. In the format of FIG. 4, a single sensing element is located within each meander of the primary winding and each grouping of interconnected sensing elements 20 provides an image pixel. Scanning of the array over an MUT then provides an image of the material properties. In the format of FIG. 5, multiple sense elements are placed between a pair of extended segments that form the primary winding. While multiplexers can be used to measure the response of the multiple sense elements within the array, it is preferable to use parallel data acquisition instrumentation to provide complete coverage, improve data acquisition rates and provide real-time imaging capabilities.

The use of multiple sensing elements with one meandering drive permits high image resolution and sensitivity to local property variations. Furthermore, the energy in the imposed magnetic field decreases exponentially with distance into the MUT with a decay constant determined by both the spatial wavelength of the primary winding and the excitation frequency. Deep penetration of the magnetic fields into the MUT and sensitivity to relatively deep defects or material property variations is then accomplished with large wavelengths and low operating frequencies. The use of absolute sensing elements with grid methods provides robust imaging of absolute conductivity that is automatically compensated for local lift-off variations as each absolute sensing element is independent of the response of the other elements. The measured properties from each absolute sensing element can then be combined together to provide a two-dimensional mapping of the material properties. These mappings can include layer thicknesses, dimensions of an object being imaged and/or other properties in addition to proximity.

In FIG. 5, the secondary elements are pulled back from the connecting portions of the primary winding to minimize end effect coupling of the magnetic field. Dummy elements 74 can be placed between the meanders of the primary to maintain the symmetry of the magnetic field, as described in U.S. Pat. No. 6,188,218, the entire teachings of which are incorporated herein by reference. When the sensor is scanned or when a feature or weld propagates across the sensor, perpendicular to the extended portions of the primary winding, secondary elements 24 in a primary winding loop adjacent to the first array of sense elements 22 provide a complementary measurement. Also, the sensor may be rotated or tilted relative to the weld or out of the plane of the surface. These arrays of secondary elements 24 can be aligned with the first array of elements 22 so that images of the material properties will be duplicated by the second array. Note that improving the signal-to-noise through combining the responses or providing sensitivity on opposite sides of a feature such as a fastener, is described in U.S. patent application Ser. Nos. 10/102,620, submitted Mar. 19, 2002, and Ser. No. 10/155,887, filed May 23, 2002, the entire teachings of which are hereby incorporated by reference. Alternatively, to provide complete coverage when the sensor is scanned transversely across a part, the sensing elements can be offset along the length of the primary loop perpendicular to the extended portions of the primary winding.

The dimensions for the sensor array geometry and the placement of the sensing elements can be adjusted to improve sensitivity for a specific inspection. For example, the effective spatial wavelength or four times the distance between the central windings 71 and the sensing elements 22 can be altered to adjust the sensitivity of a measurement for a particular inspection. For the sensor array of FIG. 5, the distance between the secondary elements 24 and the central windings 71 is smaller than the distance between the sensing elements 24 and the return windings 91. An optimum response can be determined with models, empirically or with some combination of the two. Also, most of the sensing elements 22 are located in a single row to provide the basic image of the material properties. A small number of sensing elements 24 are offset from this row to create a higher image resolution in a specific location. Other sensing elements (96 and 98) are distant from the main grouping of sensing elements at the center of the drive windings to measure relatively distant material properties, such as the base material properties for plates at a lap joint or a weld.

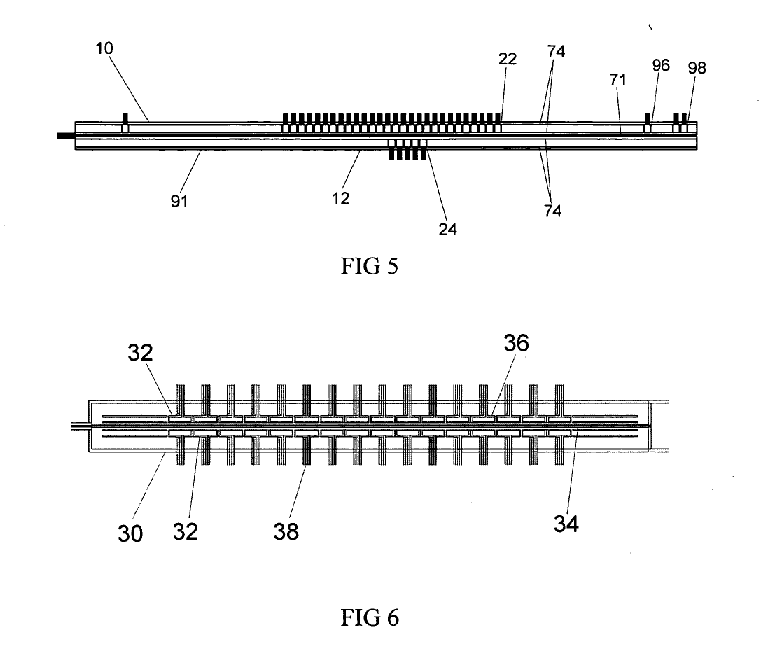

FIG. 6 shows another MWM-Array having two rows of sensing elements. This array only uses a single wavelength meandering primary winding and is described in detail in U.S. patent application Ser. Nos. 10/102,620, submitted Mar. 19, 2002, and Ser. No. 10/155,887, filed May 23, 2002, the entire teachings of which are hereby incorporated by reference. The array comprises a pair of loops forming meander primary windings 30 (FIG. 5B) and rows of secondary elements 32 within each primary winding meander. Connections 38 are made to each sensing element 36 within each row 32. The sensor array is a layered structure with the central conductors for the primary winding 34 located in the same plane as the sense elements 36 and connections 38. The remaining primary winding conductors are located in a separate plane, behind the plane of the sense elements and separated from the sense elements by a layer of insulation. The use of multiple sensing elements within one or more meanders facilitates imaging of local property variations over wide areas as the array is scanned over the MUT in a direction perpendicular to the extended portions of the primary winding and the rows of sense elements. The sensing elements have dimensions small enough to provide an imaging resolution suitable for measuring the width of the weld zones at or near the surface, e.g., HAZ at the crown of a fusion weld, HAZ and weld metal at the root of a fusion weld, or DXZ, TMZ, and HAZ regions at the back surface of an FSW. The sensing elements are aligned into a linear array so that two-dimensional images of the material properties in the weld region can be created when the array is scanned across or along the weld. Sensor arrays configured with two rows of sensing elements provide complementary images of weld features. These images can reveal differences in effective property measurements due to asymmetric material properties caused by and with respect to the weld. The use of such complementary images and scans is similar to that used for the detection of hidden flaws around fasteners as described in U.S. patent application Ser. Nos. 10/102,620.

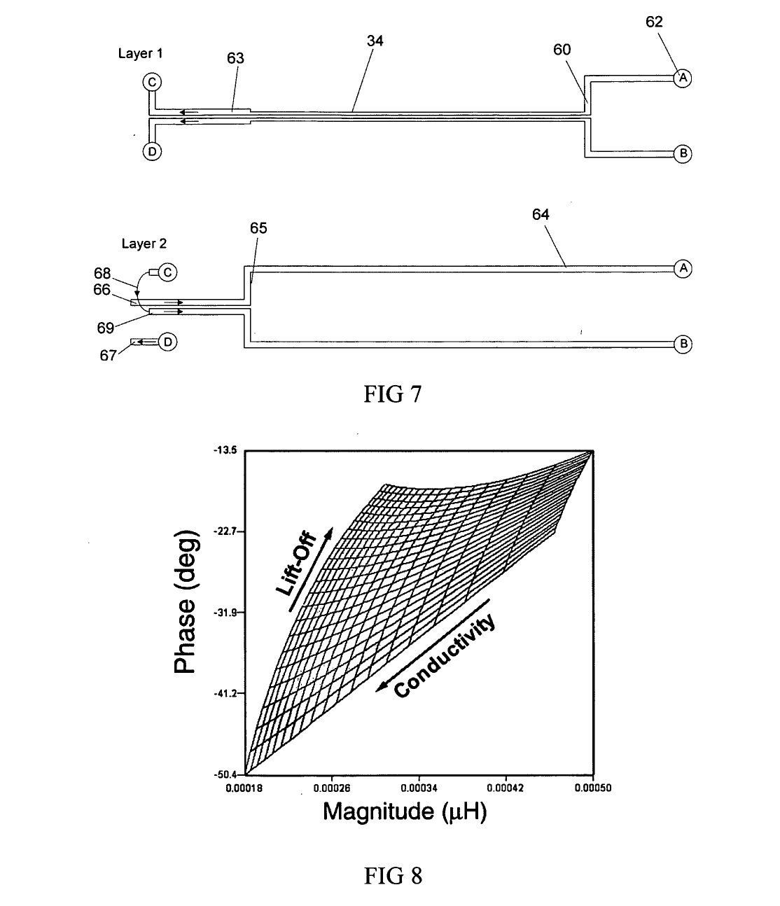

FIG. 7 shows a more detailed view of the primary winding. The central conductors 34 of the primary winding are in Layer 1. The central conductors are then connected to perpendicular conductors 60 that provide a boundary for the active area of the sensing structure and lead to vias 62 that provide pathways for connecting to Layer 2. The return conductors 64 for the primary winding are located in Layer 2 and connect to perpendicular conductors 65 that provide another boundary for the sensing structure. When fabricated, Layer 1 is placed over Layer 2 so that the via connections A, B, C, and D are vertically aligned. Except for the central conductors 34, the primary winding conductors 63 are made relatively wide to reduce the series resistance of the windings. The arrows indicate the current flow direction through the primary winding. Terminal connections to the primary winding are made to the conductors 66 and 67. The cross-connection 68 made between via C and the conductor 69 near the bond pads, which are not illustrated, maintain continuity of the current path.

An efficient method for converting the response of the MWM sensor into material or geometric properties is to use grid measurement methods. These methods map the magnitude and phase of the sensor impedance, typically generated from a model for the sensor and the layered media proximate to the sensor, into the properties to be determined and provide for a real-time measurement capability. The measurement grids are two-dimensional databases that can be visualized as “grids” that relate two measured parameters to two unknowns, such as the magnetic permeability (or electrical conductivity) and lift-off (where lift-off is defined as the proximity of the MUT to the plane of the MWM windings). For the characterization of coatings or surface layer properties, three- (or more)-dimensional versions of the measurement grids called lattices (or hypercubes) can be used. Alternatively, the surface layer parameters can be determined from numerical algorithms that minimize the least-squares error between the measurements and the predicted responses from the sensor, or by intelligent interpolation search methods within the grids, lattices or hypercubes. If the model accurately represents the geometric properties, such as the layers, of the test material then the properties obtained from these measurement grids are absolute properties. If the model does not accurately account for the aspects of the test material, such as the presence of individual layers or other spatial property variations, then the measurement grids provide effective or apparent properties that are associated with the test material and the sensor.

An advantage of the measurement grid method is that it allows for real-time measurements of the absolute electrical properties of the material and geometric parameters of interest. The database of the sensor responses can be generated prior to the data acquisition on the part itself, so that only table lookup and interpolation operations, which are relatively fast, needs to be performed. Furthermore, grids can be generated for the individual elements in an array so that each individual element can be lift-off compensated to provide absolute property measurements, such as the electrical conductivity. This again reduces the need for extensive calibration standards. In contrast, conventional eddy-current methods that use empirical correlation tables that relate the amplitude and phase of a lift-off compensated signal to parameters or properties of interest, such as crack size or hardness, require extensive calibrations using standards and instrument preparation. The database could also include other properties or parameters of interest, such as the damage conditions or even the progression of these damage conditions, for rapid assessment and decision support purposes. A representative measurement grid for a low-conductivity nonmagnetic alloy (e.g., titanium alloys, some superalloys, and austenitic stainless steels) is illustrated in FIG. 8. For coated materials, such as cadmium and cadmium alloys on steels, the properties of the coatings can be incorporated into the model response for the sensor so that the measurement grid accurately reflects, for example, the permeability variations of substrate material with stress and the lift-off.

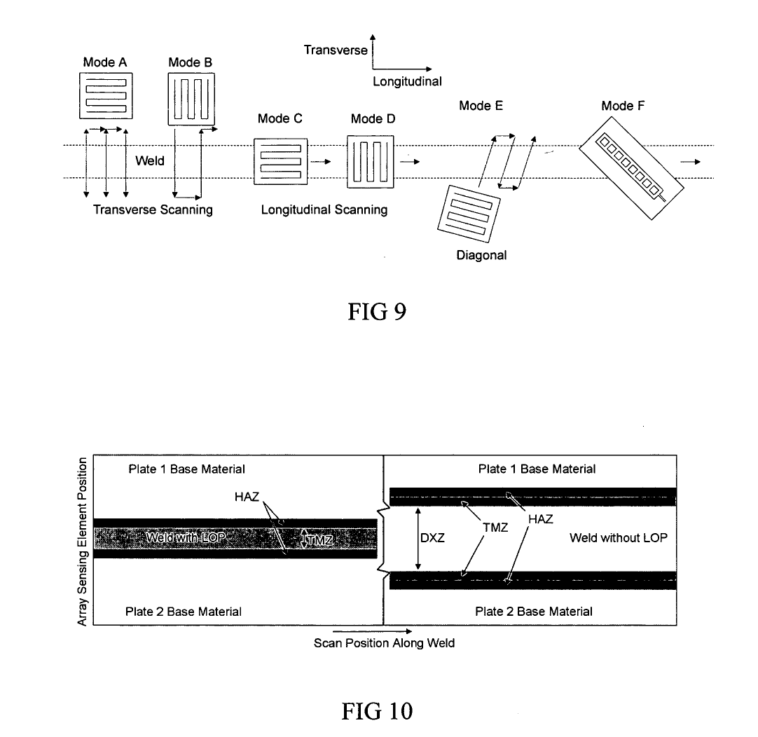

Several different types of scanning modes for post-weld inspection of FSWs, including the effects of sensor orientation with respect to the weld, are illustrated in FIG. 9. In Mode A, the extended portions (i.e., longer segments) of the primary winding are oriented parallel to the weld and the sensor is scanned across the weld in a transverse direction. In this orientation, MWM sensors and MWM-Arrays are sensitive to the material property variations associated with to some defects such as LOP but relatively insensitive to the presence of longitudinal planar flaws (such as cracks or cold laps). In Mode B, the longer segments of the primary winding are oriented perpendicular to the weld and scanned across the weld in the transverse direction. In this orientation, the MWM sensors and MWM-Array are highly sensitive to the presence of longitudinal planar flaws, such as cracks. For these transverse scanning modes, the transverse scans must be performed incrementally along the length of the weld to provide complete inspection coverage of the weld.

To increase the inspection speed along the weld, longitudinal scans can also be performed along the weld. In Mode C of FIG. 9, the longer segments of the primary winding are oriented parallel to the weld for LOP defect detection and sizing. In Mode D, the longer segments of the primary winding are oriented perpendicular to the weld for both LOP defect detection and sizing and crack detection. For the longitudinal scan modes, it is desirable, for complete coverage of the weld region, to have high resolution MWM-Arrays with multiple sensing elements spanning the weld region from the base metal on one side of the weld to the base metal on the other side of the weld. This facilitates the creation of two-dimensional images of the material property variations both across and along the weld. It is also possible to combine the advantages of both transverse and longitudinal scanning, as illustrated in Mode E of FIG. 9. For example, rotating the sensor so that the longer segments of the primary winding form a small angle with the weld axis, such as 15°, and scanning across the weld at an angle to the weld axis, such as 75°, can provide detailed images of the weld region and detect cracks in the same scan, albeit with some loss of sensitivity. Mode F of FIG. 9 shows a longitudinal scan along the weld with an MWM-Array oriented at an angle to the weld axis to further increase the resolution of the array transverse to the scan direction. Small angles are particularly useful for FSW of thin lap joints where the weld region is relatively narrow. This permits high spatial resolution across the weld while scanning along the weld. Preferably the sense elements span the weld region, even when at an angle. The position information associated with each sense element during the measurement can of course be corrected so that the locations along the weld are aligned and images of the measured properties have the correct spatial locations throughout.

The capability of single element sensors and high-resolution arrays to provide detection and sizing of LOP defects was demonstrated on FSW samples for both similar metal welds and dissimilar metal welds. For the similar metal welds, two plates of Al 2195 were joined. For the dissimilar metal welds, an Al 2219 plate was joined to an Al 2195 plate. Each FSW specimen was examined in a continuous scanning mode with the array of FIG. 6. A single scan used 15 or 16 elements in each row of sensing elements and spanned a distance of about 1.1 inches (27.9 mm) perpendicular to the scan direction. The length of scans along the samples (Mode D of FIG. 9) was between 3 inches (76 mm) and 10 inches (254 mm) and transverse to the weld (Mode B of FIG. 9) was approximately 2 inches (50.8 mm). Transverse scan speeds were 0.05 inch/sec (1.1 mm/sec). Longitudinal scan speeds ranged from 0.13 inch/sec (3.3 mm/sec) to 1.6 inch/sec (40.6 mm/sec); the higher scan speeds did not substantially degrade the quality of the measurement. The data was acquired in a fully parallel manner using multiple channel impedance measurement instrumentation, as disclosed in U.S. patent application Ser. No. 10/155,887. The scans were performed with a one-dimensional automated scanner. In these measurements, the excitation frequency ranged from relatively low, at 251 kHz for modest penetration of the magnetic field into the MUT, to relatively high at 3.98 MHz, to determine the near-surface effective electrical conductivity and proximity of the sensor to the MUT.

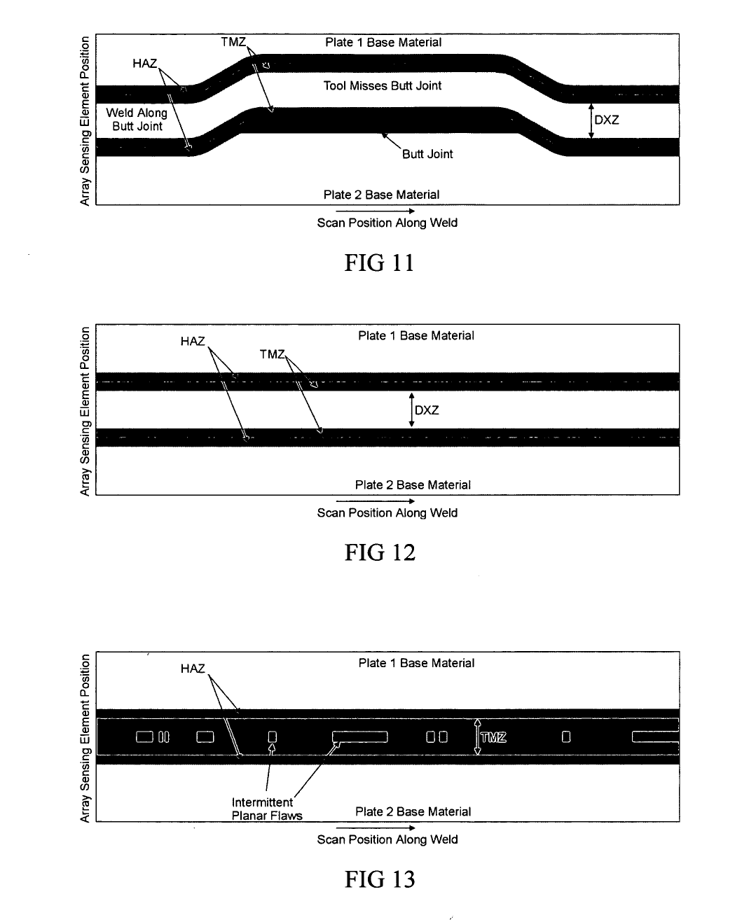

One method for inspecting the welds for defects involves making longitudinal scans with the longer segments of the primary winding oriented perpendicular to the weld (Mode D of FIG. 9). This imaging capability is illustrated in FIG. 10 for a scan down the back side of a FSW between two aluminum alloy plates. For this weld, the tool tip plunge depth was varied. On the left, the weld had an LOP defect such that the DXZ (nugget) was separated from the back side surface by TMZ. On the right the plunge depth was sufficient so that no LOP defect was present and there was a wide DXZ in the center flanked by nonrecrystallized TMZ and HAZ outside the TMZ. Another example image is shown in FIG. 11 for a scan down a weld with variable alignment of the FSW tool with respect to the butt joint between the aluminum alloy plates. In the middle area of FIG. 11 the joint between the materials is visible on the back side, indicating that the tool was not aligned with the joint. This FSW can have no LOP yet would be considered inadequate. MWM-Array scans would readily detect this unacceptable condition (a “planar flaw”). When the weld region is wider than the sensing array, multiple scans of the array can be used to capture as much of the base material and weld zone property variations as possible in the image. In each image, variations of the normalized conductivity accurately reflect microstructural variations. The detailed and quantitative local variations in the microstructural properties obtained in these scans indicate the potential to replace etching and penetrant testing as a weld inspection method. The imaging capability is illustrated further in property maps as shown in FIG. 12 for a zero LOP defect weld and FIG. 13 for a 0.06-in. LOP defect and intermittent planar flaws.

The presence of intermittent flaws is readily detected by a precipitous drop of conductivity. Often, these intermittent flaws are aligned along the original butt joint. FIG. 13 shows a schematic for a conductivity image for a 0.06-in. LOP defect in a FSW that also contains intermittent planar flaws or cracks. Here again DXZ is separated from the back side surface by TMZ. In the FSWs illustrated on the left side of FIG. 10 and in FIG. 13, an image obtained at high frequencies would reveal TMZ and HAZ, whereas a sufficiently low frequency image could bring out the DXZ as well. This is contrasted with the image of a zero LOP defect specimen (FIG. 12) that shows high frequency conductivity image along the FSW indicative of a wide uniform DXZ. This demonstrates a rapid inspection capability for the weld, as the array captures the entire conductivity profile when the sensor is scanned down the welds. In addition, the high-resolution image captures the essential features of the weld and can replace etching, which only provides a visual, non-quantitative, measure of the quality of the weld and is not environmentally friendly.

Another method for inspecting the welds for defects involved making transverse scans with the longer segments of the primary winding oriented parallel to the weld (Mode B of FIG. 9). For these transverse scans, connection to a one-dimensional automated scanner allowed high resolution (up to several thousand data points) to be obtained when traversing the weld. The individual channels from the MWM-Array allowed independent measurements of different sections along the length of the weld that permitted images of the scanned area properties to be created with a single pass of the sensor array.

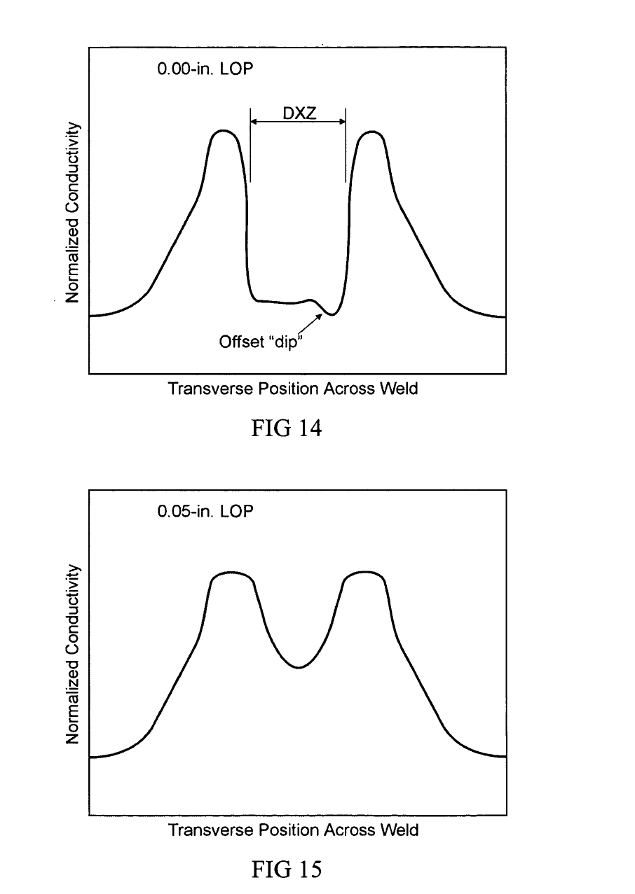

A schematic cross-sectional plot of the measured conductivities across the weld is shown in FIG. 14 for a zero LOP defect specimen and in FIG. 15 for a 0.05-in LOP defect specimen. A relatively low conductivity in the central region reflects a measurement of the DXZ. The surrounding higher conductivity regions reflect the properties of the HAZ and TMZ. The outermost regions reflect the properties of the base materials of the plates being joined. The shape of this conductivity profile for an FSW is similar to the conductivity profile obtained with conventional eddy current sensors on fusion welds, except an MWM-Array permits obtaining the entire profile across the weld simultaneously by the array of sensing elements when the array is sufficiently wide. In addition, the data can be obtained with only an air calibration of the sensor, as opposed to the use of conventional eddy current sensor measurements that require calibration on reference standards of known conductivity. With an air calibration approach, described for example in U.S. Pat. No. 6,188,218, calibration of the sensor is performed by measuring the response in air and grid measurement methods are used to determine the absolute electrical conductivity.

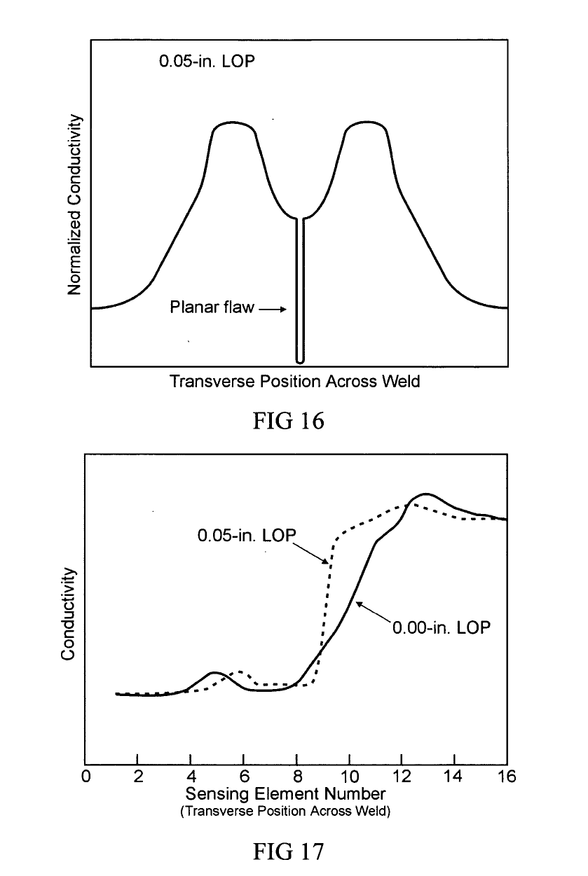

For the scans illustrated in FIG. 14 and FIG. 15, the conductivity was normalized by taking the ratio of the measured conductivity to the average conductivity measured for the base metal. High-resolution scans provide several features that permit the discrimination of no-LOP defect FSWs from FSWs with an LOP. One such feature is a wide, relatively low conductivity zone with an “offset minimum,” i.e., with a local conductivity dip at an edge of the DXZ as illustrated in FIG. 14. This local offset minimum only appears in the no-LOP plates and provides an easily observed visual representation. As illustrated in FIG. 15 and FIG. 16, this feature did not exist in the welds with LOP defects. The conductivity profiles for FSWs with LOP have distinctly different center zone shapes and widths compared to FSWs with no LOP, as illustrated in FIG. 14 and FIG. 15. FIG. 16 shows a conductivity profile for a FSW with LOP and a planar flaw. The latter is reflected in a precipitous drop in the electrical conductivity.

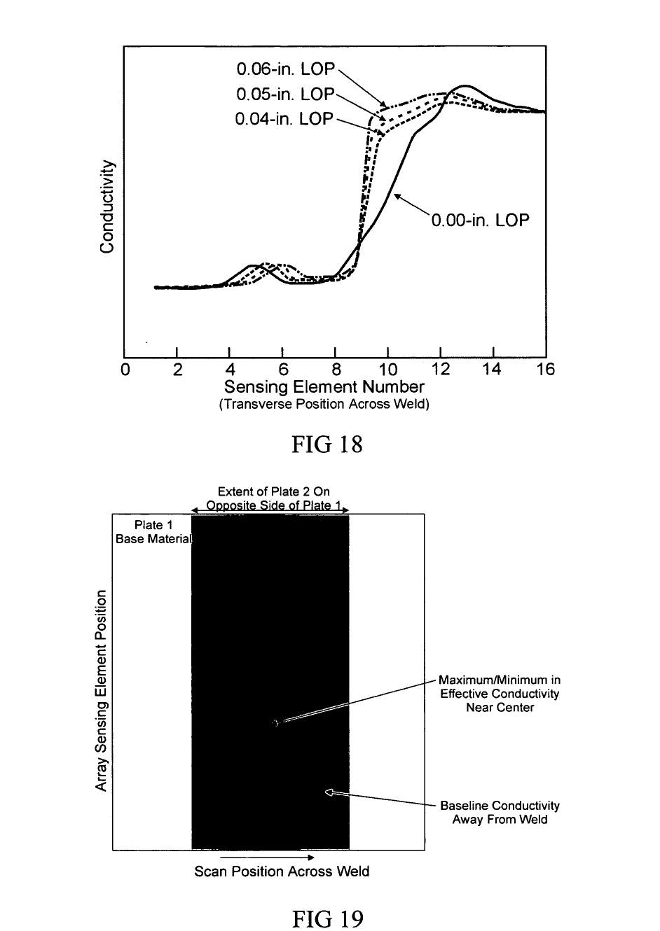

Longitudinal scans along FSWs with the longer segments of the primary winding of an MWM-Array oriented perpendicular to the weld (Mode D of FIG. 9) can also be used to determine the quality of the welds between dissimilar metals. A representative plot of the effective conductivity profile across the weld (as indicated by the sensor element channel number) is shown in FIG. 17 for a no-LOP defect weld and a 0.05-in. LOP defect weld. In this case, relatively small variations in the conductivity across the weld are masked by the large differences in the electrical conductivity of the base materials. One distinguishing feature of the weld quality is the sharpness of the transition of the electrical conductivity between the two metals. As indicated in FIG. 18, welds with an LOP defect have a sharp transition in the electrical conductivity while welds without an LOP defect have a more gradual transition. This appears to reflect the quality of the mixing of the base materials by the FSW process, with defective welds not being mixed well enough. A metric for determining the weld quality is found by normalizing the measured conductivity at sensing element 10, which provides a measure of the weld condition and one plate base material conductivity, by the measured conductivity at sensing element 1, which reflects the base material conductivity for the other plate. A normalization routine accounting for conductivity of both base metals can also be used. More sophisticated filters based on the shape of the entire conductivity profile of FIG. 18 can also be used. Images of the conductivity down the length of the weld, similar to FIG. 12, can also be created for visual inspection of the weld quality.

Similar types of images can be obtained with the friction stir welding of lap joints. In the case of a lap joint FSW, one inspection goal is to verify or qualify that the tool rotation direction was correct during the welding process. This can use a simple model of an infinite half space of conducting material with a conductivity, a, and a sensor proximity, h. Then using an inversion method, such as the grid methods, images of conductivity and lift-off are produced as the sensor is scanned across the lap joint in either a transverse or longitudinal scan direction along the back surface (e.g., opposite the side from which the FSW tool was inserted). One or more frequencies are used, preferably two, to maximize speed and provide the minimum information needed to insure robustness. When the wrong tool rotation is used the conductivity does not vary substantially near the surface on the backside. Under this condition the infinite half space model is a good approximation and the lift-off image is uniform at high frequencies. When the tool rotates in the correct direction, the conductivity near the back surface is not uniform in the transverse direction within the region near the surface. Thus for the correct rotation, the lift-off image reveals the presence of the non-uniform property introduced by the proper weld condition. Similarly, the speed of the tool tip can affect the apparent width of the weld region in the conductivity image.

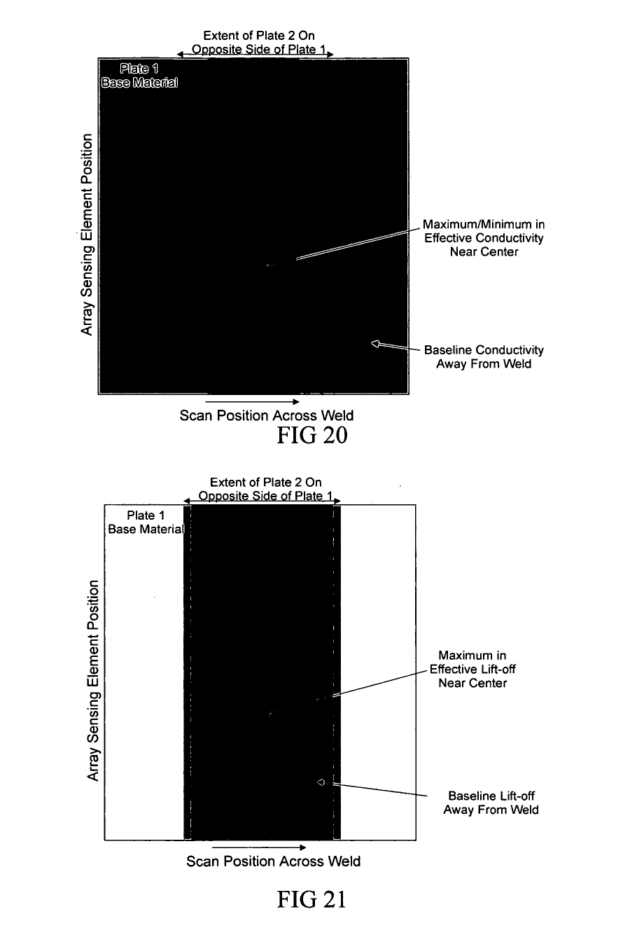

Schematic images of the effective conductivity for a MWM-Array oriented with the extended drive segments parallel to the weld axis are shown in FIG. 19 for a low measurement frequency and FIG. 20 for a high measurement frequency. The sensor array is scanned over the material side opposite the friction stir weld and the welding parameters (tool rotation direction, rotation rate, pin length, travel speed, etc.) are considered nominal. The lower measurement frequency probes more of the material affected by the welding process and may be selected to penetrate through the layer of material nearest to the sensor. In contrast, the higher frequency is more sensitive to the near surface material properties. The image of FIG. 20 indicates that the frequency was high enough so that the sensor did not penetrate through the near material layer. In both images, the effective conductivity is fairly uniform across the array and tends to change essentially monotonically toward the center of the weld axis from either side. Whether the effective conductivity becomes a minimum or a maximum near the center of the weld depends upon the properties of the base material layers, such as the electrical conductivity, the magnetic permeability, and thickness. The selection of the measurement frequencies also depends upon the layer properties. For aluminum alloys such as 2024, 7055, and 7574 that are 0.040 inches to 0.100 inches thick, a low measurement frequency is approximately 15.8 kHz while a high measurement frequency is approximately 158 kHz. Of course, similar images could be created for the effective permeability of magnetizable materials.

The corresponding schematic images for the effective lift-off are shown in FIG. 21 for a low measurement frequency and FIG. 22 for a high measurement frequency. Both images again show uniform properties across the array and an increase in the effective lift-off toward the center of the weld. However, when the weld conditions are changed, such as reversing the rotation direction of the tool tip (i.e., clockwise instead of the nominal clock-wise direction), the property images can be affected. FIG. 23 shows the change in the high frequency effective lift-off associated with a reversed tool tip rotation direction. There is an occasional increase in the effective lift-off near the center, but it is non-uniform along the weld. There are also areas of reduced lift-off. The differences between the images obtained from nominal and perturbed weld conditions indicate that these property measurements can be used to determine if the welds were performed with proper settings of the tooling.

Quantitative features from the conductivity data obtained with high-resolution scans facilitate weld quality assessment and permit automation of accept/evaluate decisions required for production applications. In production environments, these features can be obtained with longitudinal scans using a high resolution MWM-Array and should be sufficient to qualify most good welds and identify a suspect population. Transverse scanning with its inherently higher resolution may be required locally for evaluation of suspect sections identified by longitudinal scans. This evaluation should provide discrimination between relatively small LOP defects that might not be detrimental, e.g., less than 0.05 in., and larger LOP defects and, thus, provide a basis for acceptance or rejection.

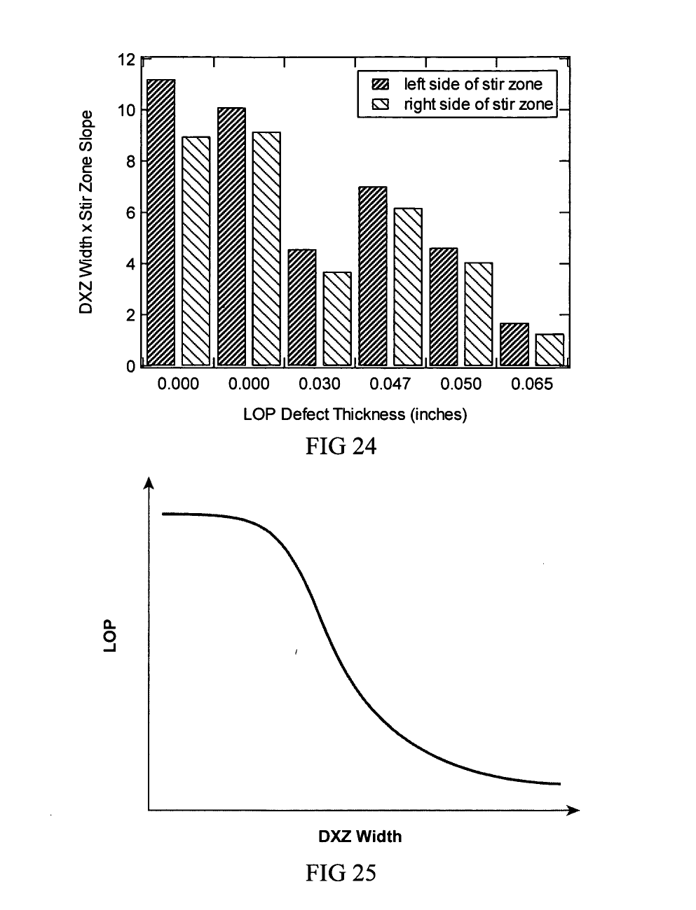

One simple quantitative feature is the product of the width of the center zone multiplied by the slope of the sides of this zone. The slope at the sides and the width are computed from a derivative image, which requires many data points in this region. This product is plotted as a function of LOP defect size in FIG. 24. Another simple feature is the measurement of the width of the DXZ, plotted in FIG. 25, or the center zone of the conductivity profile. This permits the assignment of welds into three categories: (1) good for welds with a relatively wide center zone, (2) bad for welds with a relatively narrow center zone, and (3) suspect for welds with intermediate center zone widths. If scans on additional panels confirm that no-LOP FSWs have wide center zone widths that are distinctly greater than in the FSWs with LOP less than 0.050-in., then this simple feature would be sufficient and may be robust enough alone to qualify good welds. If significant portions of good welds fall in the intermediate range, or if some good welds have the width-slope product comparable to the 0.047-in. LOP defect shown in FIG. 24, then one of the additional features, such as the presence of the local conductivity dip at an edge of the DXZ observed on the no-LOP specimens or other shape filters, would be required to further evaluate these welds. Another feature that can reflect the quality of the weld is the value of the minimum of the electrical conductivity in the center region of the weld, which tends to be relatively low for no-LOP FSW. The use of a shape matching filter could provide a robust characterization of the weld quality since it uses all of the information in the conductivity profile. An example shape matching filter could compare the measured conductivity profile to the profile of a reference FSW known to be without defects. No-LOP defect welds would have a high correlation with the reference FSW while FSWs with LOP would have a low correlation. Moreover, differences between FSWs with different LOP thickness can be readily recognized and even quantified by a variety of image recognition techniques. These techniques can be applied to 2-D or 3-D images of conductivity, including conductivity of the nugget itself.

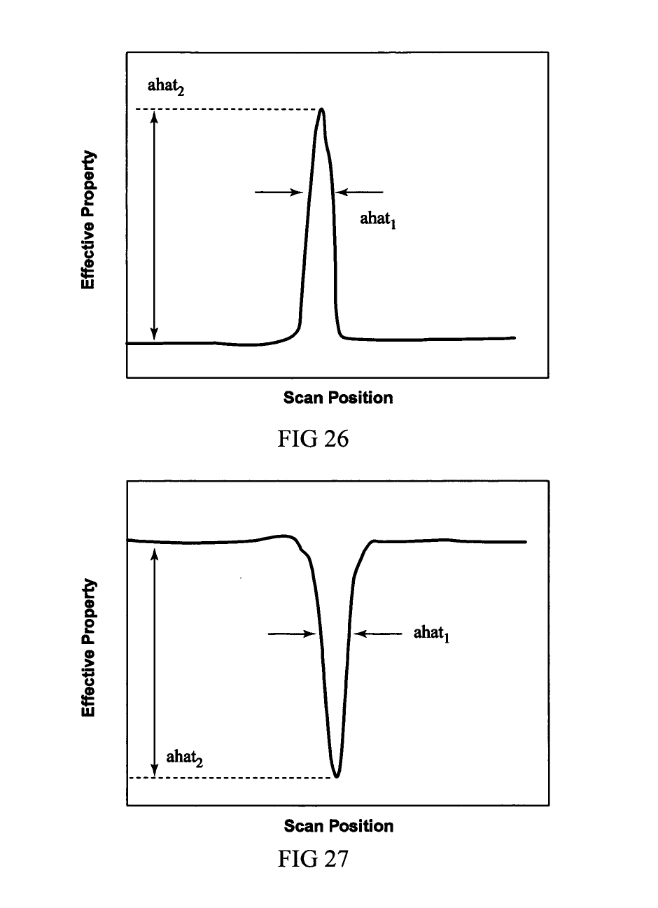

Combinations of features obtained from measurements of the effective properties over the weld region can also be used to determine the acceptability of a weld and the welding process parameters. FIG. 26 and FIG. 27 show representative plots of an effective property, such as the effective conductivity or lift-off, across a lap joint weld. In FIG. 26, the property is larger in the weld region than in the areas distant to the weld region and is at a maximum in the center of the weld. In FIG. 27, the materials are different than those for FIG. 26 and the property is at a minimum in the weld region. These scans can be made with single element sensors or with a single element of an array. In each scan, two characteristic features are shown: ahat₁, which indicates the width of the weld region, and ahat₂, which indicates the magnitude of the property change associated with the weld. Appropriate values for each feature depend upon the material electrical and geometric properties as well as the weld control parameters. Ranges of acceptable values are typically determined from measurements on test panels that cover the operating parameters of interest. Other features could also be used, such as the sharpness of the peak signal. Here, the effective property was normalized to the effective property of that material distant from the weld. The level of the effective property for determining the ahat₁ value could be chosen based on measurements on reference or training set panels or as the width at half maximum value for the weld region.

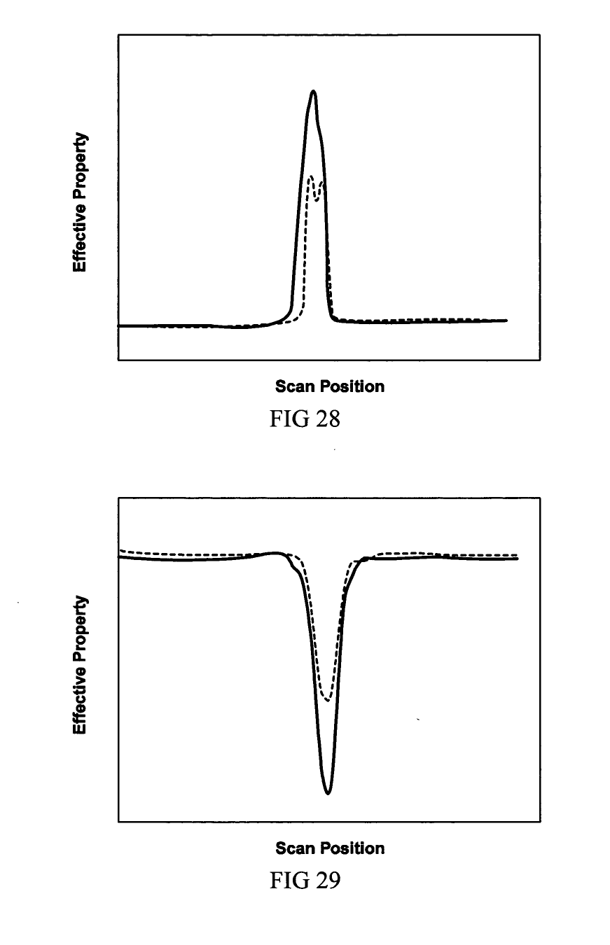

Changes in the nominal weld control parameters, such as the tool rotation direction, plunge depth, pin length, travel speed, tool plunge force, and tool rotation rate, will affect the quality of the weld and also the effective measured properties. FIG. 28 shows the effect of a change in nominal weld parameters for the material of FIG. 26 while FIG. 29 shows the effect for the material of FIG. 27. In FIG. 28 and FIG. 29, the solid line indicates the nominal weld parameters while the dashed line indicates the perturbed weld parameters. In both cases, changing the weld parameters changes the effective property scan response and also the scan response features, such as ahat₁ and ahat₂.

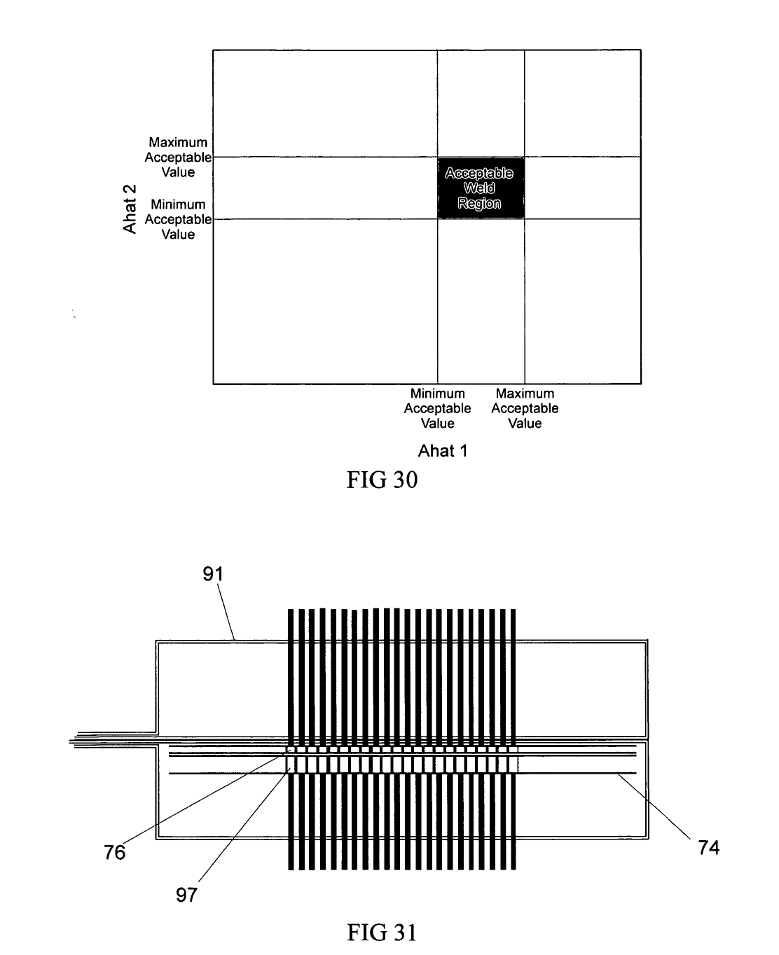

One way of capturing these response changes for the purpose of determining weld parameter acceptability is to plot the response from multiple features. FIG. 30 shows a schematic plot of ahat₂ versus ahat₁. Minimum and maximum acceptable values for each feature can be determined from training sets of test panels. The use of multiple measurement features provides for more robust weld characterization than a single scan because it is less likely that an unacceptable weld will have all of the features of an acceptable weld. For example, reversing the rotation direction may affect only the magnitude of the property change (ahat₂) while leaving the width parameter ahat₁ unchanged. Under other conditions, ahat₁ may be changed while ahat₂ unchanged. Ensuring that the measurement scan has two or more features associated with “good” or nominal weld conditions then provides a more robust weld assessment.

One or more of these features can also be tracked for assessing the weld process parameters as part of a statistical process control methodology. A feature or features can be tracked for day, months, or other time period and monitored to determine that it stays within acceptable bounds. Otherwise, if the process exceeds the acceptable bounds, some action is taken to bring the process back within acceptable bounds or the process is terminated.

One protocol for FSW inspection is to scan with a longitudinal high resolution MWM-Array at a high frequency, such as 4 MHz, and to categorize welds into wide, intermediate and narrow. Then for suspect sections of the FSWs, local transverse scans should be performed at several locations to identify the local off-center minimum feature typical of good welds and employ other shape filters. If this feature is not present and/or the weld does not pass appropriate shape filters, the weld would be categorized as having a LOP defect.

In one embodiment, a single high frequency measurement is made of conductivity and proximity at each sensing element to measure only the near surface properties of the material in the weld. In another embodiment, multiple frequencies are used to determine the variation of material properties with depth from the surface. In another embodiment, a single frequency is used but sense elements are placed at different distances to the drive winding to sample different portions of the magnetic field in a segmented field manner. The sense elements further from the drive winding sample magnetic fields that tend to penetrate deeper into the test material so that sense elements at different distances to the drive winding sample different segments of the magnetic field. One example array, shown in FIG. 6 and described in U.S. patent application Ser. Nos. 10/155,887, filed on May 23, 2002, and Ser. No. 10/454,383, filed on the Jun. 3, 2003, the entire teachings of which are incorporated herein by reference, has a second array of sense elements 97 further from the central drive windings than the first array of sense elements 76. Also in this case the elements 97 are larger than the elements 76 so that the both sets of elements would link the same amount of magnetic flux when the sensor array is in air as the magnetic field decays with distance from the primary winding windings.

These methods may also include the generation of three dimensional images of the DXZ using model based methods that model the magnetic field interactions with the nugget using either analytical methods or numerical methods (e.g., finite element methods). In one embodiment, the model is used to generate measurement grids and higher dimensional databases, respectively, of sensor responses to the DXZ zone property variations. Example estimated properties of the DXZ are the width of the penetration region at the base of the weld and the width of the DXZ at a selected depth from the base of the weld. The multiple frequency imaging method is then used to estimate these two parameters using a combination of measurement grid table look-ups, and intelligent root searching methods. Multiple layered but two dimensional model might be used to estimate other parameters of the model, e.g., the thickness of a near surface uniform region, in order to provide better sensitivity than the simple infinite half space model. In another method a three dimensional model might be used to represent the weld and other parameters of the model might be estimated.

Determining the thickness and microstructural variations within the near-surface LOP zone are an extension of the multiple frequency coating characterization and property profiling methods described in U.S. Pat. No. 6,377,039 and ASTM Standard E2338-04, the entire contents of which are incorporated herein by reference. The multiple frequency coating characterization algorithm can be used to independently estimate three unknown material properties simultaneously. For the LOP zone in a friction stir weld, this algorithm can be used to estimate the absolute conductivity in the LOP zone and its thickness independently. Combined with the use of high-resolution MWM-Array sensing elements, this permits three-dimensional imaging of the LOP zone. The sensor array can also be used to characterize subsurface features such as porosity, cracks, lack of fusion, material condition and properties before and after heat treatment (or other processes), as well as other material anomalies or property distributions that affect metal product, component, or weld quality.

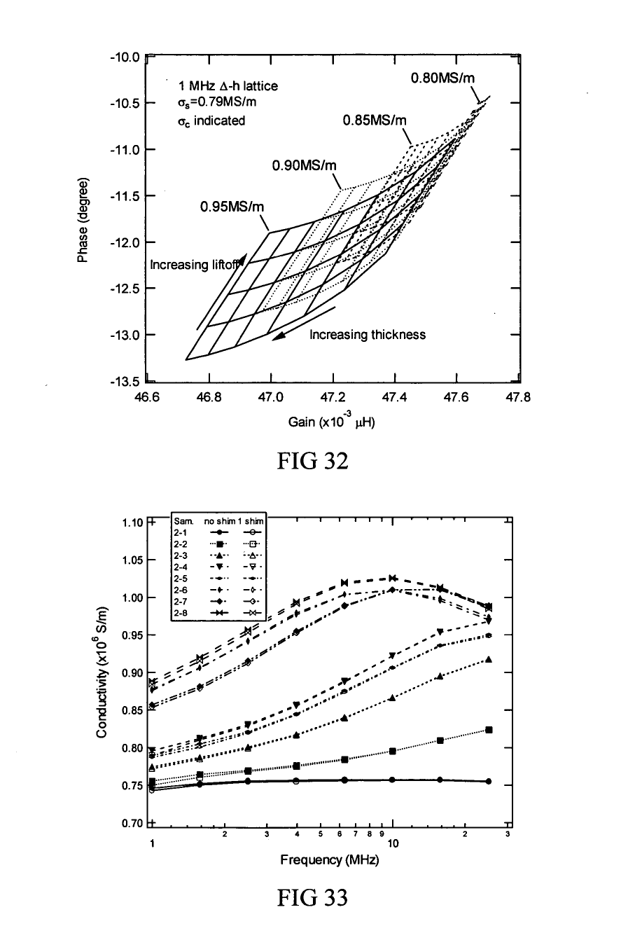

In the coating characterization algorithm, sensor responses for ranges of property variations are calculated and stored in databases. In this algorithm, the measurement grids provide a two-dimensional database of the sensor response. The grids are created in advance by varying the coating thickness (or LOP zone thickness), and lift-off over the range of interest for a given coating conductivity (or LOP zone conductivity). In a grid lattice, measurement grids are created for a range of coating conductivities that span the range of interest for a given material, forming a three-dimensional database for the sensor response. A representative grid lattice for the characterization of turbine blade coatings is shown in FIG. 32. The lattice shows coating thickness-lift-off grids for four coating conductivities at a single frequency. In each measurement grid, the spacing between the grid points illustrates the sensitivity for independently estimating the coating thickness and the lift-off. The grid spacing and sensitivity is large when the coating and the substrate have significantly different conductivities; the grid collapses when the conductivities of the coating and the substrate are equal, which is expected for an uncoated specimen.

The coating characterization algorithm uses the measurement grid lattices to determine a set of coating properties (such as LOP conductivity, LOP thickness, and lift-off) that are independent of frequency. Alternatively, a non-linear least squares method can be used to minimize the error between the predicted response from a model for the property variations with depth and the measured data at multiple frequencies and/or multiple lift-offs. Computationally, the grid lattice approach, which only uses table look-ups and simple interpolations, tends to be faster than the non-linear least squares approach, which generally require multiple calculations from simulation model that can be complicated. Hybrid methods can improve the speed of the non-linear least squares approach and permit a real-time measurement capability by using precomputed grid lattices for the sensor responses in place of the calculations from the model.

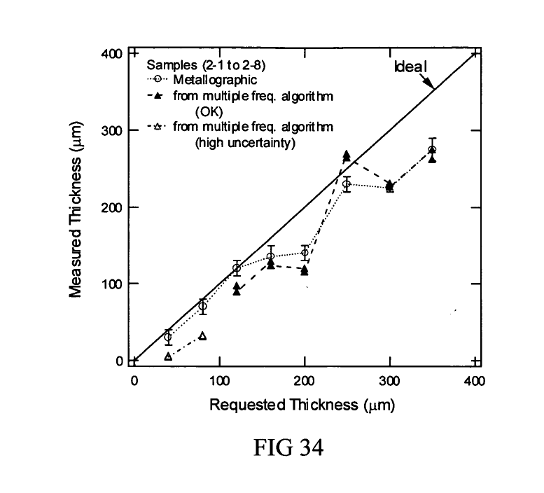

A representative application of the three-parameter estimation algorithm is the determination of coating conductivity, coating thickness, and lift-off of a MCrAlY bond coat on an IN738 substrate. The effective conductivity is plotted against the frequency in FIG. 33. For the uncoated specimens, the conductivity is constant with frequency. For the coated specimens, the low-frequency response approaches the substrate conductivity as the skin depth of the magnetic field becomes large compared to the coating thickness. The high-frequency response approaches the coating conductivity as the skin depth of the magnetic field becomes small compared to the coating thickness. The data with a 25 micron (1 mil) thick shim placed between the sensor and the specimens yields exactly the same effective conductivity estimate as the data without a shim, which provides confidence in the quality of the calibration and the measurements. As shown in FIG. 34, there is good agreement with destructive metallographic measurements of the coating thickness for coatings thicknesses of 100 to 350 micrometers (0.004 to 0.014 in.).

One of the limitations of the use of inductive secondary coils in magnetometers is the depth of sensitivity to deep features, such as imaging of the nugget properties in an FSW. For a spatially periodic primary winding structure, the dimension of the spatial periodicity can be termed the spatial wavelength λ. The depth of penetration of the magnetic field into the MUT is then related to both λ and the conventional skin depth; the penetration depth is limited to approximately λ/6 at low frequencies, and the skin depth at high frequencies. Thus, at low frequencies, increasing the wavelength increases the depth of penetration and allows the sensor to be sensitive to deeper features. However, the induced voltage on the secondary coils is proportional to the rate of change of the magnetic flux with time, or the excitation frequency, so that the frequency cannot be lowered indefinitely otherwise the signal is lost in measurement noise. To overcome these low-frequency limitations, alternative sensing elements based on solid-state device technology, such as Giant magnetoresistive (GMR) devices, Hall effect devices, and SQUIDS, can be used. In particular, sensing element arrays that use GMR sensors permit inspection measurements down to low frequencies, such as 50 Hz or even dc, for characterization of relatively thick plates, such as 0.5 inch aluminum-lithium alloy plates. Another technique for increasing the depth of penetration of an MWM-Array is to shape the magnetic field with the geometry of the primary winding. This allows for relatively long wavelength excitations with modest sensor footprints. The use of a GMR sensor as the sensing element in a magnetometer and the use of arrays of sensing elements and rectangular winding structures are described in U.S. patent application Ser. No. 10/045,650, submitted Nov. 8, 2001, the entire contents of which are hereby incorporated.

Similar methods can be applied to the characterizing of joined dielectric materials. These materials are insulating or poorly conducting and are typically characterized by the conductivity and dielectric constant or complex permittivity. These material properties are influenced by a variety of physical processes, such as porosity, stress, temperature, contamination and moisture content, which may be introduced as part of the joining process. These properties can be measured with electric field sensors, such as IDEDs, described in U.S. Pat. Nos. 4,814,690 and 6,380,747 and in U.S. patent application Ser. Nos. 10/040,797, filed Jan. 7, 2002, and Ser. No. 10/225,406, filed Aug. 20, 2002, the entire teachings of which are hereby incorporated by reference.

While the inventions have been particularly shown and described with reference to preferred embodiments thereof, it will be understood to those skilled in the art that various changes in form and details may be made therein without departing from the spirit and scope of the invention as defined by the appended claims. References incorporated by reference in their entirety:
Arbegast, W. J., and Hartley, P. J. (1998), “Friction Stir Weld Technology Development at Lockheed Martin Michoud Space, Systems—An Overview”, 5^{th} International EWI Conference on Trends in Welding Research, 1-5 June, 1998, Pine Mountain, Ga.
Ditzel, P., and Lippold, J. C. (1997), “Microstructure Evolution During Friction Stir Welding of Aluminum Alloy 6061-T6”, Edison Welding Institute, Summary Report SR9709.
Goldfine, N., Schlicker, D., Sheiretov, Y., Washabaugh, A., Zilberstein, V., Lovett, T., “Conformable Eddy-Current Sensors And Arrays For Fleetwide Gas Turbine Component Quality Assessment,” ASME Turbo Expo Land, Sea, & Air 2001, 4-7 June, 2001, New Orleans, La.
Nondestructive Testing Handbook, 2^{nd} Edition, Volume 4: Electromagnetic Testing, American Society for Nondestructive Testing, 1986.

While this invention has been particularly shown and described with references to preferred embodiments thereof, it will be understood by those skilled in the art that various changes in form and details may be made therein without departing from the scope of the invention encompassed by the appended claims.

1. A method for characterizing friction stir welds in a test material, said method comprising:
placing a sensor in proximity to the test material;
passing a time varying electric current through the sensor to form a magnetic field;
measuring at least one effective property associated with the test material and sensor at plural sensor locations, including at least one location near a center of the weld and at least one location away from a weld region; and
using a feature of the effective property measurement to assess at least one welding process parameter.

2. A method as claimed in claim 1 wherein the sensor has a drive winding with at least one linear extended portion and a first plurality of sense elements parallel to the at least one linear extended portion.

3. A method as claimed in claim 2 further comprising:
orienting the at least one linear extended portion of the sensor parallel to a weld axis; and
translating the sensor perpendicular to the weld axis.

4. A method as claimed in claim 2 further comprising:
orienting the at least one linear extended portion of the sensor perpendicular to a weld axis; and
translating the sensor parallel to the weld axis.

5. A method as claimed in claim 2 further comprising:
orienting the at least one linear extended portion of the sensor at an angle to the weld axis; and
translating the sensor parallel to the weld axis.

6. A method as claimed in claim 5 wherein the angle is less than 45 degrees.

7. A method as claimed in claim 2 further comprising a second plurality of sense elements parallel to the at least one linear extended portion of the drive.

8. A method as claimed in claim 7 wherein the second plurality of sense elements are at a different distance to the at least one linear extended portion of the drive than the first plurality of sense elements.

9. A method as claimed in claim 1 wherein the effective property is electrical conductivity.

10. A method as claimed in claim 1 wherein the effective property is magnetic permeability.

11. A method as claimed in claim 1 wherein the effective property is lift-off.

12. A method as claimed in claim 1 wherein the feature is a width of the weld region.

13. A method as claimed in claim 1 wherein the feature is a change in the effective property at the center of the weld relative to an effective property value distant from the weld.

14. A method as claimed in claim 1 wherein at least two features are used to assess the welding parameter.

15. A method as claimed in claim 1 wherein the at least one welding parameter is a pin tool rotation direction.

16. A method as claimed in claim 1 wherein the at least one welding parameter is a pin tool rotation rate.

17. A method as claimed in claim 1 wherein the at least one welding parameter is a pin tool plunge force.

18. A method as claimed in claim 1 wherein the at least one welding parameter is a pin tool travel speed.

19. A method as claimed in claim 1 further comprising:
varying the electric current sinusoidally in time at an at least one prescribed excitation frequency.

20. A method as claimed in claim 19 wherein there are multiple excitation frequencies.

21. A method as claimed in claim 20 wherein the at least one excitation frequency ranges from 100 Hz to 100 MHz.

22. A method as claimed in claim 1 further comprising:
determining several effective properties simultaneously with a pre-computed database of sensor responses.

23. A method as claimed in claim 1 further comprising:
assessing the welding parameter for statistical process control.

24. A method for characterizing friction stir welds in a lap joint test material, said method comprising:
placing a sensor in proximity to the test material;
passing a time varying electric current through the sensor to form a magnetic field;
measuring at least one effective property associated with the test material and sensor at plural sensor locations, including at least one location near the center of the weld and at least one location away from the weld region; and
comparing a feature of the effective property measurement to a corresponding feature obtained from measurements on a reference material to assess at least one welding process parameter.

25. A method as claimed in claim 24 wherein the sensor has a drive winding with at least one linear extended portion and a first plurality sense elements parallel to an extended portion.

26. A method as claimed in claim 25 further comprising:
orienting the at least one extended portion of the sensor parallel to the weld axis; and
translating the sensor perpendicular to the weld axis.

27. A method as claimed in claim 25 further comprising:
orienting the at least one extended portion of the sensor perpendicular to the weld axis; and
translating the sensor parallel to the weld axis.

28. A method as claimed in claim 25 further comprising:
orienting the at least one extended portion of the sensor at an angle to the weld axis; and
translating the sensor parallel to the weld axis.

29. A method as claimed in claim 25 further comprising a second plurality of sense elements parallel to the at least one extended portion of the drive.

30. A method as claimed in claim 29 wherein the second plurality of sense elements are at a different distance to the at least one extended portion of the drive than the first plurality of sense elements.

31. A method as claimed in claim 24 wherein the effective property is electrical conductivity.

32. A method as claimed in claim 24 wherein the effective property is lift-off.

33. A method as claimed in claim 24 wherein the effective property is magnetic permeability.

34. A method as claimed in claim 24 wherein the feature is a change in the effective property at the center of the weld relative to an effective property value distant from the weld.

35. A method as claimed in claim 24 wherein the feature is a uniformity of the effective property along the weld.

36. A method as claimed in claim 24 wherein the feature is a width of the weld region.

37. A method as claimed in claim 24 wherein at least two features are used to assess the welding parameter.

38. A method as claimed in claim 24 wherein the welding parameter is a pin tool rotation direction.

39. A method as claimed in claim 24 further comprising:
varying the electric current sinusoidally in time with at least two prescribed excitation frequencies.

40. A method as claimed in claim 39 wherein a lower frequency of the at least two excitation frequencies provides sensor sensitivity to materials on an opposite side of a near layer of the lap joint.

41. A method as claimed in claim 24 further comprising:
using a pre-computed database of sensor responses to determine several effective properties simultaneously.
